(19) United States
(12) Patent Application Publication
(10) Pub. No.: US 2024/0420944 A1
(43) Pub. Date: Dec. 19, 2024

(54) HIGH RESOLUTION TIME-OF-FLIGHT MASS SPECTROMETER AND METHODS OF PRODUCING THE SAME

(71) Applicant: Academia Sinica, Taipei City (TW)

(72) Inventors: Yi-Sheng WANG, Taipei City (TW); Yi-Hong CAI, Keelung City (TW)

(21) Appl. No.: 18/701,598

(22) PCT Filed: Oct. 12, 2022
(86) PCT No.: PCT/US2022/046489

§ 371 Date: Apr. 15, 2024

Related U.S. Application Data
(60) Provisional application No. 63/256,852, filed on Oct. 18, 2021.

(51) Int. Cl. H01J 49/40; H01J 49/10

(52) U.S. Cl. CPC H01J 49/40; H01J 49/10

(57) ABSTRACT

Provided herein are designs of a linear time-of-flight (TOF) mass spectrometer that achieves a high mass resolving power (MRP) to ions independently having a mass-to-charge (m/z) ratio between 1,000 and 100,000. The TOF mass spectrometer comprises an ion source, a flight tube, and an ion detector, in which the ion source comprises a sample plate, an extraction plate disposed at a first distance (d1) away from the sample plate; an end plate disposed at a second distance (d2) away from the extraction plate; a first electric field (e1) present between the sample plate and the extraction plate; and a second electric field (e2) present between the extraction plate and the end plate; the flight tube having a length of d3 is disposed downstream and adjacent to the ion source; and the ion detector is disposed downstream and adjacent to the flight tube; and the linear TOF mass spectrometer satisfies the set of criteria I or II, in which the set of criteria I includes (1) d1/L<0.035, in which L is the sum of d1, d2, and d3; (2) d2/L≥0.05; and (3) e2/e1≤2.5; while the set of criteria II includes, (1) d1/L≥0.035; and (2) d2/L≥0.003.

### CROSS-REFERENCE TO RELATED APPLICATIONS

This application claims priority and the benefit of U.S. Provisional Patent Application No. 63/256,852, filed Oct. 18, 2021, the entirety of which is incorporated herein by reference.

### BACKGROUND OF THE INVENTION

### 1. Field of the Invention

The present disclosure relates in general, to time-of-flight (TOF) mass spectrometers, particularly to TOF mass spectrometers that achieve a high mass resolving power (MRP), such as the TOF mass spectrometer with an MPR over 100,000 for ions of mass-to-charge (m/z) ratio between 1,000 and 100,000.

### 2. Description of Related Art

Time-of-flight (TOF) mass spectrometers are popular mass analyzers in modern analytical science. A TOF mass spectrometer determines the mass-to-charge (m/z) ratio of ions based on the time they fly across a certain distance. Such mass analyzers have the simplest instrument configuration while providing a superior resolution that is only next to Fourier-transform (FT) mass spectrometers. Although an FT mass analyzer provides higher mass resolving power (MRP) than a TOF mass spectrometer, an FT mass spectrometer is much more complicated, expensive, and difficult to operate. In modern mass spectrometry (MS), resolution is the key factor determining the capability of an instrument to solve analytical questions. The development of high-resolution mass spectrometer has shown a huge impact on the blooming of analytical sciences in biochemical researches, especially in proteomics and metabolomics.

Due to the increasing demands in high-resolution analytical techniques for fundamental researches, clinical applications, and many industries, improving the performance of TOF-type mass analyzers is highly desirable.

The MRP of a peak in a mass spectrum is the ratio of the peak's central mass to its peak width. In TOF mass spectrometer, MRP is half of the peak's resolution in time domain:

$$MRP = m / Δ m = t / 2 Δ t$$

where m represents the mass of the ion, t is the total flight time of an ion in a TOF mass spectrometer, and Δm or Δt is the full-width at half-maximum of the spectral feature in m/z and time domain, respectively. Since a TOF mass spectrometer consists of an ion source and a flight tube, the t includes the time the ion spends in both the ion source and the flight tube regions. In TOF mass spectrometer, Δt (and subsequently the Δm) is mainly dependent on the position and velocity spreads of ions inside the ion source region. For instance, in a TOF mass spectrometer equipped with a matrix-assisted laser desorption/ionization (MALDI) or laser desorption ionization (LDI) ion source, the initial position spread depends on the sample morphology, whereas the velocity spread depends on the local sample temperature during laser excitation. Typically, the MRP of a linear MALDI-TOF mass spectrometer is in the range of a few thousands and that of a FT mass spectrometer is in the range of 10⁵⁻⁶. To increase the MRP of MALDI-TOF mass spectrometer, a method to reduce the impact of position and velocity spreads on the total flight time is necessary.

A typical MALDI-TOF mass spectrometer consists of a Wiley and Mclaren type ion source and an ion reflector in the field-free drift region. The ion source employs a two-stage ion acceleration configuration and delayed ion extraction technique to partially reduce Δt. The delayed extraction is a method to activate the ion extraction voltage with a time delay after laser excitation. Unfortunately, the conventional design of Wiley and Mclaren type ion source cannot provide a satisfactory improvement in MRP in a linear TOF mass spectrometer. An ion reflector, or commonly known as a reflectron, can further compensate the energy difference of ions by reflecting their trajectory in the field-free drift region. Although a reflectron improve the MRP considerably, a serious problem is the ion loss due to the limited ion survivor time as well as inappropriate ion trajectory after reflection. Thus, the conventional TOF mass spectrometer always needs to make compromise between pursuing MRP and keeping sensitivity.

Although improving MRP and sensitivity of mass spectrometer techniques is a constant subject, an effective means to enhance the resolution of linear TOF-type mass analyzers is still unavailable. Therefore, there exists in this art a need of novel designs of TOF mass spectrometer that could achieve high MRP, particularly, MRP above 100,000.

### SUMMARY

The present invention concerns design of a linear time-of-flight (TOF) mass spectrometer that achieves high mass resolving power (MRP), particularly, MRP that is greater than 100,000. Accordingly, the first objective of the present disclosure is to provide a linear TOF mass spectrometer, which comprises an ion source, a flight tube, and an ion detector, in which
the ion source comprises
   a sample plate,
   an extraction plate disposed at a first distance (d1) away from the sample plate;
   an end plate disposed at a second distance (d2) away from the extraction plate;
   a first electric field (e1) present between the sample plate and the extraction plate; and
   a second electric field (e2) present between the extraction plate and the end plate;
the flight tube having a length of d3 is disposed downstream and adjacent to the ion source; and
the ion detector is disposed downstream and adjacent to the flight tube; and
the linear TOF mass spectrometer satisfies criteria of,
   (1) d1/L<0.035, in which L is the sum of d1, d2, and d3;

$$d 2 / L \geq 0.05 ; and \qquad ( 2 )$$

$$e 2 / e 1 \leq 2.5 ; \qquad ( 3 )$$

thereby achieving MRP greater than 10,000 to ions independently having a mass-to-charge (m/z) ratio between 1,000 and 100,000.

According to some preferred embodiments, the L is 20 to 500 cm, and the e2/e1 is 0.5 to 2.5.

Also encompassed in the present disclosure is a method of producing the linear TOF mass spectrometer described above, the method includes steps of:
(a) specifying the m/z ratio of ions to be analyzed;
(b) specifying the total distance (L);
(c) adjusting respective positions of the extraction plate and the end plate so that the TOF mass spectrometer satisfies the criteria of,

$$d 1 / L < 0.035 ; and \qquad ( 1 )$$

$$d 2 / L \geq 0.05 ; \qquad ( 2 )$$

and
(d) adjusting the first and second electric fields so that the TOF mass spectrometer satisfies the criterion of (3) e2/e1≤2.5.

According to some preferred embodiments, the L is 20-500 cm; and the e2/e1 is above 0.5.

Alternatively or optionally, the method further includes specifying the initial velocity of the ions to be analyzed.

It is the second objective of the present disclosure to provide a linear TOF mass spectrometer that achieves high MRP, such as greater than 10,000. The TOF mass spectrometer comprises an ion source, a flight tube, and an ion detector, in which
the ion source comprises
   a sample plate,
   an extraction plate disposed at a first distance (d1) away from the sample plate;
   an end plate disposed at a second distance (d2) away from the extraction plate;
   a first electric field (e1) present between the sample plate and the extraction plate; and
   a second electric field (e2) present between the extraction plate and the end plate;
the flight tube having a length of d3 is disposed downstream and adjacent to the ion source; and
the ion detector is disposed downstream and adjacent to the flight tube; and
the linear TOF mass spectrometer satisfies criteria of,
   (1) d1/L≥0.035, in which L is the sum of d1, d2, and d3; and

$$d 2 / L \geq 0.003 ; \qquad ( 2 )$$

thereby achieving a mass resolving power (MRP) greater than 10,000 to ions independently having m/z ratio between 1,000 and 100,000.

Also encompassed in the present disclosure is a method of producing the linear TOF mass spectrometer described herein, the method comprises:
(a) specifying the m/z ratio of ions to be analyzed;
(b) specifying the total distance (L);
(c) adjusting respective positions of the extraction plate and the end plate so that the TOF mass spectrometer satisfies the criteria of,
(1) d1/L≥0.035, in which L is the sum of d1, d2, and d3; and

$$d 2 / L \geq 0.003 . \qquad ( 2 )$$

Alternatively or optionally, the method further includes specifying the initial velocity of the ions. According to preferred embodiments of the present disclosure, the ions to be analyzed independently has an initial velocity between 10 to 1,000 m/s.

Examples of the ion source suitable for use in the present TOF mass spectrometer include, but are not limited to, a matrix-assisted laser desorption/ionization (MALDI), a laser desorption/ionization (LDI), an electrospray ionization (ESI) source, and the like.

According to embodiments of the present disclosure, the centers of the extraction and end plates of the present TOF mass spectrometer are respectively covered by a mesh.

According to embodiments of the present disclosure, the end plate the present TOF mass spectrometer is grounded.

The details of one or more embodiments of the invention are set forth in the accompanying description below. Other features and advantages of the invention will be apparent from the detail descriptions, and from claims.

### BRIEF DESCRIPTION OF THE DRAWINGS

The present description will be better understood from the following detailed description read in light of the accompanying drawings, where:

FIG. 1 is a schematic diagram depicting the layout of a conventional TOF mass spectrometer 100;

FIG. 2 is a line graph depicting the change of MRP of ions of m/z 1,000 with the change of e2/e1 in accordance with one embodiment of the present disclosure, in which L=60 cm, d1=8 mm, d2=44 mm; and a total voltage of 25 kV;

FIG. 3 is a line graph depicting the change of MRP of ions of m/z 1,000 with the change of e2/e1 in accordance with one embodiment of the present disclosure, in which L=60 cm, d1=8 mm, d2=78 mm, and a total voltage of 25 kV;

FIG. 4 is a line graph depicting the change of MRP of ions of m/z 10,000 with the change of e2/e1 in accordance with one embodiment of the present disclosure, in which L=60 cm, d1=8 mm, d2=78 mm, and a total voltage of 25 kV;

FIG. 5 is a line graph depicting the change of MRP of ions of m/z 100,000 with the change of e2/e1 in accordance with one embodiment of the present disclosure, in which L=60 cm, d1=8 mm, d2=162 mm, and a total voltage of 25 kV;

FIG. 6 is a line graph depicting the change of MRP of ions of m/z 10,000 with the change of e2/e1 in accordance with one embodiment of the present disclosure, in which L=120 cm, d1=8 mm, d2=154 mm, and a total voltage of 25 kV; and

FIG. 7 is a line graph depicting the change of MRP of ions of m/z 10,000 with the change of e2/e1 in accordance with one embodiment of the present disclosure, in which L=60 cm, d1=25 mm, d2=10 mm, and a total voltage of 25 kV.

### DESCRIPTION OF THE PREFERRED EMBODIMENTS

Embodiments of the present invention are hereinafter described in detail with reference to the drawings. The present disclosure concerns a TOF mass spectrometer configured to achieve high MRP and high sensitivity simultaneously; and methods for producing such TOF mass spectrometer.

### I. The Present TOF Mass Spectrometer

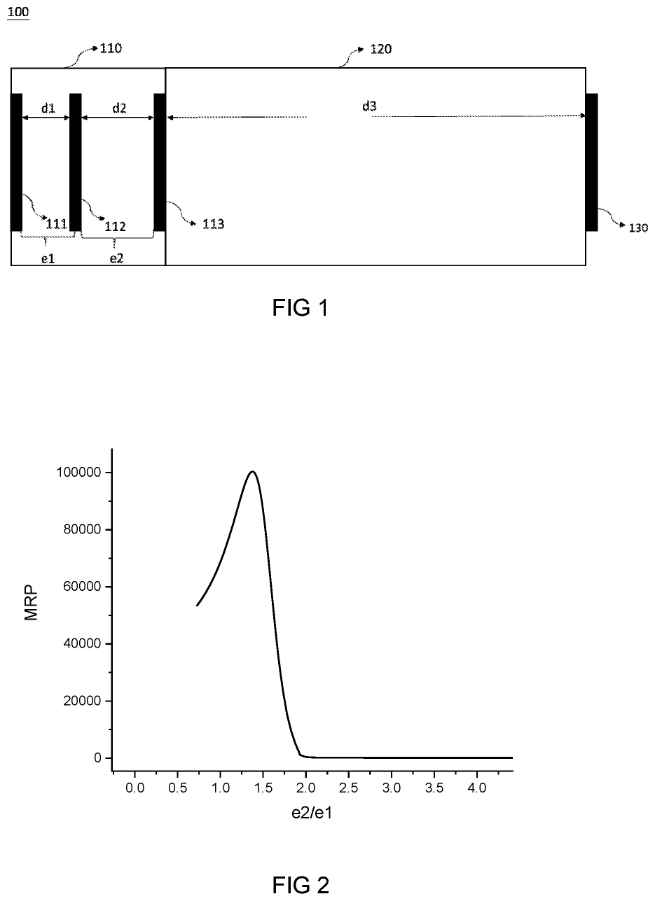

Referring to FIG. 1, which is a schematic diagram depicting the basic structure of a conventional linear TOF mass spectrometer 100. The TOF mass spectrometer 100 includes in its structure, at least, an ion source 110, a flight tube 120, and an ion detector 130. The ion source 110 includes a sample plate 111, an extraction plate 112, and an end plate 113. Preferably, the extraction plate 112 is disposed downstream to and away from the sample plate 111, by a first distance (d1); and the end plate 113 is disposed downstream to and away from the extraction plate 112, by a second distance (d2). In general, samples are placed on the surface of the sample plate 111 and ionized by a pulsed laser beam. The three plates 111, 112, 113 are biased at a voltage gradient that pushes the ionized sample (or the sample ions) towards the detector 130. Preferably, the voltage gradient consists of a first electric field (e1) present in the region between the sample plate 111 and the extraction plate 112, and a second electric field (e2) present in the region between the extraction plate 112 and the end plate 113. In order to produce homogeneous electric fields, the respective centers of the extraction plate 112 and the end plate 113 are covered by metal meshes. It is known that when d1 or d2 is above a certain distance, say 1 cm, additional plates in between the sample and extraction plates or between the extraction and the end plates are needed to ensure the uniform electric field. The sample ions, upon being pushed by the voltage gradient, will then travel across the flight tube 120, which has a length of d3, and independently reaches the detector 130 in accordance with its mass-to-charge (m/z) ratio.

It is generally believed that the mass resolving power (MRP) of a linear TOF mass spectrometer increases with increasing distance of the flight tube, because the flight time (t) of ions increases with increasing distance of the flight tube. In the present disclosure, the inventors discover that, instead of improving MRP by increasing the distance of the flight tube, it may be improved more efficiently by reducing Δt. Accordingly, the first aspect of the present disclosure relates to a TOF mass spectrometer as depicted in FIG. 1 configured to achieve MRP greater than 10,000 for ions independently having a mass-to-charge (m/z) ratio between 1,000 and 100,000 provided that the TOF mass spectrometer satisfies the following criteria,
(1) d1/L<0.035, in which L is the sum of d1, d2, and d3;

$$d 2 / L \geq 0.05 ; and \qquad ( 2 )$$

$$e 2 / e 1 \leq 2.5 . \qquad ( 3 )$$

Once the instrument configuration satisfies the criteria (1) to (3) described above, the thus constructed TOF mass spectrometer may achieve MRP above 10,000 for ions independently having m/z ratio between 1,000 and 100,000.

According to some preferred embodiments of the present disclosure, the L is 20 to 500 cm, and the e2/e1 is 0.5 to 2.5. In one preferred embodiment, the TOF mass spectrometer is configured to have d1, d2 and L respectively equal 0.8 cm, 4.4 cm, and 60 cm, and e2/e1 equal 1.376, thereby producing MRP of 100,373 for ions independently having m/z ratio of 1,000 In another preferred embodiment, the TOF mass spectrometer is configured to have d1, d2 and L respectively equal 0.8 cm, 7.8 cm, and 60 cm, and e2/e1 equal 1.007, thereby producing MRP of 14,968,600 for ions independently having m/z ratio of 1,000. In a further embodiment, the TOF mass spectrometer is configured to have d1, d2 and L respectively equal 0.8 cm, 7.8 cm, and 60 cm, and e2/e1 equal 1.008, thereby producing MRP of 114,987 for ions independently having m/z ratio of 10,000. In still a further embodiment, the TOF mass spectrometer is configured to have d1, d2 and L respectively equal 0.8 cm, 16.2 cm, and 60 cm, and e2/e1 equal 0.535, thereby producing MRP of 118,574 for ions independently having m/z ratio of 100,000. In another embodiment, the TOF mass spectrometer is configured to have d1, d2 and L respectively equal 0.8 cm, 15.4 cm, and 120 cm, and e2/e1 equal 0.956, thereby producing MRP of 104,020 for ions independently having m/z ratio of 10,000.

Accordingly, the present disclosure also pertains to a method of constructing the linear TOF mass spectrometer described above, the method includes steps of:
(a) specifying the m/z ratio of ions to be analyzed;
(b) specifying the total distance (L);
(c) adjusting respective positions of the extraction plate and the end plate so that the TOF mass spectrometer satisfies the criteria of,

$$d 1 / L < 0.035 ; and \qquad ( 1 )$$

$$d 2 / L \geq 0.05 ; \qquad ( 2 )$$

and
(d) adjusting the first and second electric fields so that the TOF mass spectrometer satisfies the criterion of (3) e2/e1<2.5.

Alternatively or optionally, the method further includes specifying the initial velocity of the ions intended to analyze. Preferably, the ions intended to analyze are independently set to have an initial velocity ranges between 10 to 1,000 m/s in the TOF mass spectrometer, such as 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 191, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 656, 657, 658, 659, 660, 661, 662, 663, 664, 665, 666, 667, 668, 669, 670, 671, 672, 673, 674, 675, 676, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 9.5, 906, 907, 908, 909, 910, 911, 912, 913, 914, 915, 916, 917, 918, 919, 920, 921, 922, 923, 924, 925, 926, 927, 928, 929, 930, 931, 932, 933, 934, 935, 936, 937, 938, 939, 940, 941, 942, 943, 944, 945, 946, 947, 948, 949, 950, 951, 952, 953, 954, 955, 956, 957, 958, 959, 960, 961, 962, 963, 964, 965, 966, 967, 968, 969, 970, 971, 972, 973, 974, 975, 976, 977, 978, 979, 980, 981, 982, 983, 984, 985, 986, 987, 988, 999, 990, 991, 992, 993, 994, 995, 996, 997, 998, 999 and 1,000 m/s; more preferably, each ions is set to have an initial velocity between 100 to 900 m/s in the TOF mass spectrometer, such as 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 191, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 656, 657, 658, 659, 660, 661, 662, 663, 664, 665, 666, 667, 668, 669, 670, 671, 672, 673, 674, 675, 676, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, and 900 m/s; most preferably, each ions is set to have an initial velocity between 150 to 880 m/s in the TOFMS, such as 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 191, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 656, 657, 658, 659, 660, 661, 662, 663, 664, 665, 666, 667, 668, 669, 670, 671, 672, 673, 674, 675, 676, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, and 880 m/s. According to some embodiments of the present disclosure, the ions to be analyzed are independently set to have an initial velocity of 167 m/s. According to further embodiments of the present disclosure, the ions to be analyzed are independently set to have an initial velocity of 878 m/s.

### II. Alternative Design of the Present TOF Mass Spectrometer

Optionally, or alternatively, the TOF mass spectrometer as depicted in FIG. 1 is constructed to achieve high MRP, such as greater than 10,000, for ions independently having m/z ratio between 1,000 and 100,000, provided that the TOF mass spectrometer satisfies the following criteria,
(1) d1/L≥0.035, in which L is the sum of d1, d2, and d3; and

$$d 2 / L \geq 0.003 . \qquad ( 2 )$$

Once the instrument configuration satisfies the criteria (1) to (2) described in this alternative embodiment, the thus constructed TOF mass spectrometer may achieve MRP greater than 100,000 for ions independently having m/z ratio between 1,000 and 100,000.

According to some preferred embodiments, the L is 20-500 cm; and the e2/e1 is above 0.5. In one preferred embodiment, the TOF mass spectrometer is configured to have d1, d2 and L respectively equal 2.5 cm, 1.0 cm, and 60 cm, and e2/e1 equal 6.222, thereby producing MRP of 264,396 for ions independently having m/z ratio of 10,000.

The present disclosure thus pertains to a method for constructing the present TOF mass spectrometer, and the methods includes steps of,
(a) specifying the m/z ratio of ions to be analyzed;
(b) specifying the total distance (L);
(c) adjusting respective positions of the extraction plate and the end plate so that the TOF mass spectrometer satisfies the criteria of,
(1) d1/L≥0.035, in which L is the sum of d1, d2, and d3; and

$$d 2 / L \geq 0.003 . \qquad ( 2 )$$

Alternatively or optionally, the method further includes specifying the initial velocity of the ions intended to analyze. Preferably, the ions intended to analyze are independently set to have an initial velocity ranges between 10 to 1,000 m/s in the TOF mass spectrometer, such as 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 191, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 656, 657, 658, 659, 660, 661, 662, 663, 664, 665, 666, 667, 668, 669, 670, 671, 672, 673, 674, 675, 676, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 9.5, 906, 907, 908, 909, 910, 911, 912, 913, 914, 915, 916, 917, 918, 919, 920, 921, 922, 923, 924, 925, 926, 927, 928, 929, 930, 931, 932, 933, 934, 935, 936, 937, 938, 939, 940, 941, 942, 943, 944, 945, 946, 947, 948, 949, 950, 951, 952, 953, 954, 955, 956, 957, 958, 959, 960, 961, 962, 963, 964, 965, 966, 967, 968, 969, 970, 971, 972, 973, 974, 975, 976, 977, 978, 979, 980, 981, 982, 983, 984, 985, 986, 987, 988, 999, 990, 991, 992, 993, 994, 995, 996, 997, 998, 999, and 1,000 m/s; more preferably, each ions is set to have an initial velocity between 100 to 900 m/s in the TOF mass spectrometer, such as 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 191, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 656, 657, 658, 659, 660, 661, 662, 663, 664, 665, 666, 667, 668, 669, 670, 671, 672, 673, 674, 675, 676, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, and 900 m/s; most preferably, each ions is set to have an initial velocity between 150 to 880 m/s in the TOF mass spectrometer, such as 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 191, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 656, 657, 658, 659, 660, 661, 662, 663, 664, 665, 666, 667, 668, 669, 670, 671, 672, 673, 674, 675, 676, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, and 880 m/s. According to some embodiments of the present disclosure, the ions to be analyzed are independently set to have an initial velocity of 167 m/s. According to further embodiments of the present disclosure, the ions to be analyzed are independently set to have an initial velocity of 878 m/s.

The singular forms “a”, “an”, and “the” are used herein to include plural referents unless the context clearly dictates otherwise.

The present invention will now be described more specifically with reference to the following embodiments, which are provided for the purpose of demonstration rather than limitation.

### Example Identifying Criteria of TOF Mass Spectrometer Having Optimal MRP

To find out criteria of TOF mass spectrometer, mass spectra of ions independently having a mass ranged between 1,000 and 10,000 were produced via TOF mass spectrometer configured in accordance with parameters listed in Table 1 below, and results are illustrated in FIGS. 2 to 7.

TABLE 1
Parameters of TOF mass spectrometer

| Mass | d1 | d2 | L | | | Ve | e1 | e2 | | |
|---|---|---|---|---|---|---|---|---|---|---|
| (Da) | (cm) | (cm) | (cm) | d1/L | d2/L | (V) | (V/m) | (V/m) | e2/e1 | MRP |
| 1,000 | 0.8 | 4.4 | 60 | 0.013 | 0.073 | 2918 | 364,750 | 501,864 | 1.376 | 100,373 |
| 1,000 | 0.8 | 7.8 | 60 | 0.013 | 0.130 | 2312 | 289,000 | 290,872 | 1.007 | 14,968,600 |
| 10,000 | 0.8 | 7.8 | 60 | 0.013 | 0.130 | 2309 | 288,625 | 290,910 | 1.008 | 114,987 |
| 100,000 | 0.8 | 16.2 | 60 | 0.013 | 0.270 | 2111 | 263,875 | 141,290 | 0.535 | 118,574 |
| 10,000 | 0.8 | 15.4 | 120 | 0.013 | 0.128 | 1289 | 161,500 | 153,948 | 0.956 | 104,020 |
| 10,000 | 2.5 | 1.0 | 60 | 0.042 | 0.017 | 7166 | 286,640 | 1783,400 | 6.222 | 264,396 |

FIGS. 2 to 7 respectively depict changes of MRP of ions with the change of e2/e1, in which MRP of each instance (i.e., FIGS. 2 to 7) was calculated by use of respective set of parameters listed in Table 1.

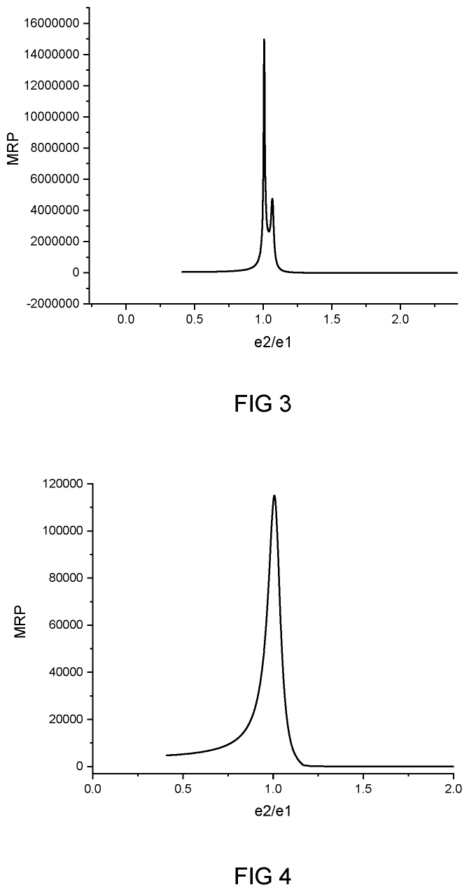

References are first made to FIGS. 2 and 3, in FIG. 2, the MRP of ions of m/z 1,000 was calculated using following parameters: d1=0.8 cm, d2=4.4 cm, L=60 cm. The corresponding d1/L and d2/L were 0.013 and 0.073, respectively. With an appropriate e2/e1, such as below 1.83, the peak width of the ion in time-domain spectra could be reduced to less than 0.5 ns. Thus, the highest MRP could be achieved when e2/e1=1.38, in such condition the extraction voltage difference would be 2,918 V. Based on the same d1 and L (i.e., d1=0.8 cm, L=60 cm), increasing d2 could also lead to higher MRP if a suitable e2/e1 is selected, as long as d2/L is larger than 0.05. FIG. 3 shows the result obtained with the same d1 and L, except d2 was increased to 78 mm; in such case, d2/L was 0.13. It was found that high MRP could not be achieved when the ratio of e2/e1 was above 1.5. The highest MRP was achieved only when e2/e1 equaled to 1.01.

Referring now to FIG. 4, in which same parameters (i.e., the same d1, d2, and L as used in FIGS. 2 and 3) of TOF mass spectrometer were applied to ions of m/z 10,000. As depicted, the highest MRP was achieved when e2/e1 equaled 1.01, which corresponded to an extraction voltage difference of 2,309 V. Although the best MRP in this case was only 1% of that for ions of m/z=1,000, yet the MRP was still well above 100,000.

Turning to FIG. 5, which depicts the changes of MRP with changes of e2/e1 for ions independently having the m/z ratio of 100,000. Note that in this instance, d1 was fixed at 0.8 cm, while d2 was increased to 162 mm. It was found that the best MRP was achieved when e2/e1 equaled 0.53, which corresponded to an extraction voltage difference of 2,111 V.

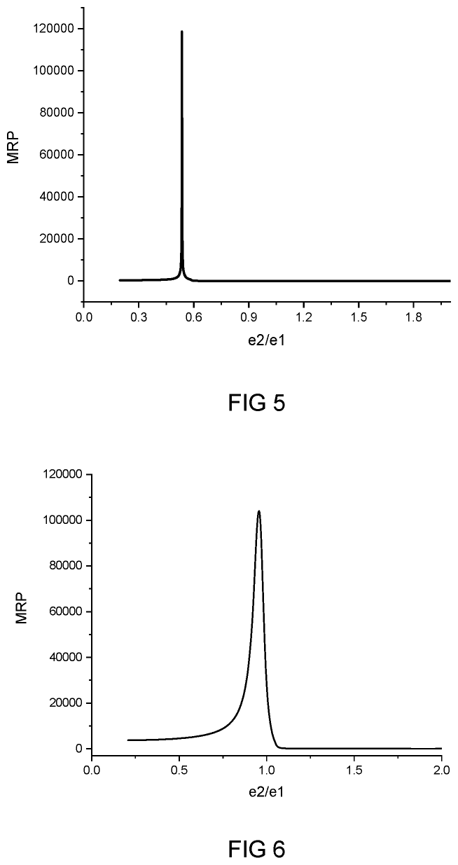

Additionally, it was also found that, for high mass ions, high MRP could be achieved by increasing the total distance L, as long as the critical parameters are satisfied. FIG. 6 shows that for ions of m/z 10,000, high MRP was achieved by specifying L to be 120 cm. The resultant MRP profile was similar to that in FIG. 4, except the e2/e1 for the highest MRP now equaled 0.956, instead of 1.01 as in FIG. 4. In this design, the d2/L was 0.128, satisfying the condition that d2/L should be greater than 0.05.

Taken together, the results indicated that for ions independently having the m/z ratio between 1,000 to 100,000, high MRP may be achieved as long as the TOF mass spectrometer satisfied the criteria of,

$$d 1 / L < 0.035 ; \qquad ( 1 )$$

$$d 2 / L \geq 0.05 ; and \qquad ( 2 )$$

$$e 2 / e 1 \leq 2.5 . \qquad ( 3 )$$

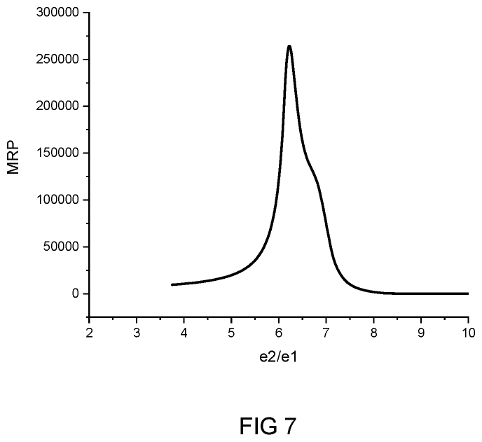

FIG. 7 depicts changes in MRP for ions of m/z 10,000 with the change of e2/e1. Note that in contrast to the criterion (i.e., d1/L<0.035) set forth in FIGS. 2 to 6, in this particular instance, d1/L≥0.035 (d1=2.5 cm, d2=1.0 cm, and L=60 cm). Accordingly, in this case, d1/L and d2/L were 0.0417 and 0.0167, respectively, and the highest MRP was achieved when e2/e1 equaled 6.2. Taken together, the finding in FIG. 7 indicated that, for mass spectra produced in the condition of d1/L≥0.035, high MRP could be achieved when d2/L was kept in the range above 0.003.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A linear time-of-flight (TOF) mass spectrometer comprising an ion source, a flight tube, and an ion detector, in which
the ion source comprises,
a sample plate,
an extraction plate disposed at a first distance (d1) away from the sample plate;
an end plate disposed at a second distance (d2) away from the extraction plate;
a first electric field (e1) present between the sample plate and the extraction plate; and
a second electric field (e2) present between the extraction plate and the end plate;
the flight tube having a length of d3 is disposed downstream and adjacent to the ion source; and
the ion detector is disposed downstream and adjacent to the flight tube; and
the linear TOF mass spectrometer satisfies criteria of,
(1) d1/L<0.035, in which L is the sum of d1, d2, and d3;
$$d 2 / L \geq 0.05 ; and \qquad ( 2 )$$
$$e 2 / e 1 \leq 2.5 ; \qquad ( 3 )$$
thereby achieving a mass resolving power (MRP) greater than 10,000 to ions independently having a mass-to-charge (m/z) ratio between 1,000 and 100,000.

2. The TOF mass spectrometer of claim 1, wherein
the L is 20-500 cm; and
the e2/e1 is 0.5-2.5.

3. The TOF mass spectrometer of claim 1, wherein the ion source is selected from the group consisting of a matrix-assisted laser desorption/ionization (MALDI), a laser desorption/ionization (LDI), and an electrospray ionization (ESI) source.

4. The TOF mass spectrometer of claim 1, wherein the centers of the extraction and end plates are independently covered by a mesh.

5. The TOF mass spectrometer of claim 1, wherein the end plate is grounded.

6. A method of producing the linear TOF mass spectrometer of claim 1, the method comprises:
(a) specifying the m/z ratio of ions to be analyzed;
(b) specifying the total distance (L);
(c) adjusting respective positions of the extraction plate and the end plate so that the TOF mass spectrometer satisfies the criteria of,
$$d 1 / L < 0.035 ; and \qquad ( 1 )$$
$$d 2 / L \geq 0.05 ; \qquad ( 2 )$$
and
(d) adjusting the first and second electric fields so that the TOF mass spectrometer satisfies the criterion of (3) e2/e1≤2.5.

7. The method of claim 6, further comprising specifying the initial velocity of the ions to be analyzed prior to the step (b).

8. The method of claim 7, wherein the initial velocity of the ions to be analyzed is between 10 to 1,000 m/s.

9. A linear time-of-flight (TOF) mass spectrometer comprising an ion source, a flight tube, and an ion detector, in which
the ion source comprises
a sample plate,
an extraction plate disposed at a first distance (d1) away from the sample plate;
an end plate disposed at a second distance (d2) away from the extraction plate;
a first electric field (e1) present between the sample plate and the extraction plate; and
a second electric field (e2) present between the extraction plate and the end plate;
the flight tube having a length of d3 is disposed downstream to the ion source; and
the ion detector is disposed at a position adjacent to the flight tube; and
the linear TOF mass spectrometer satisfies criteria of,
(1) d1/L≥0.035, in which L is the sum of d1, d2, and d3; and
$$d 2 / L \geq 0.003 ; \qquad ( 2 )$$
thereby achieving a mass resolving power (MRP) greater than 10,000 to ions independently having a mass-to-charge (m/z) ratio between 1,000 and 100,000.

10. The TOF mass spectrometer of claim 9, wherein
the L is 20-500 cm; and
the e2/e1 is above 0.5.

11. The TOF mass spectrometer of claim 9, wherein the ion source is selected from the group consisting of a matrix-assisted laser desorption/ionization (MALDI), a laser desorption/ionization (LDI), and an electrospray ionization (ESI) source.

12. The TOF mass spectrometer of claim 9, wherein the centers of the extraction and end plates are respectively covered by a mesh.

13. The TOF mass spectrometer of claim 9, wherein the end plate is grounded.

14. A method of producing the linear TOF mass spectrometer of claim 9, the method comprises:
(a) specifying the m/z ratio of the ion to be analyzed;
(b) specifying the total distance (L);
(c) adjusting respective positions of the extraction plate and the ended plate so that the TOF mass spectrometer satisfies the criteria of,
(1) d1/L≥0.035, in which L is the sum of d1, d2, and d3; and
$$d 2 / L \geq 0.003 . \qquad ( 2 )$$

15. The method of claim 14, further comprising specifying the initial velocity of the ions to be analyzed prior to the step (b).

16. The method of claim 14, wherein the ions to be analyzed independently has an initial velocity between 10 to 1,000 m/s.
